(19) United States
(12) Patent Application Publication
(10) Pub. No.: US 2012/0116948 A1
(43) Pub. Date: May 10, 2012

(54) GRAPHIC PROCESSING APPARATUS FOR STOCK/FUTURES TRADING CONDITIONS

(75) Inventors: Wook Choi, Seoul (KR); Jong Pil Lee, Seoul (KR)

(73) Assignee: KOREA EXCHANGE, INC., Busan (KR)

(21) Appl. No.: 13/386,026

(22) PCT Filed: Jun. 4, 2010
(86) PCT No.: PCT/KR10/03606

§ 371 Date: Jan. 19, 2012

(30) Foreign Application Priority Data
Jul. 28, 2009 (KR) 10-2009-0068746

(51) Int. Cl. G06Q 40/04

(52) U.S. Cl. 705/37

(57) ABSTRACT

The invention relates to a graphic processing apparatus for stock/futures trading conditions is configured by systematically linking and deploying: a computing module capable of deriving various pieces of stock/futures trading information reflecting stock/futures trading conditions by stock/futures trading times and prices, within a communication pipeline at an exchange system; a computing module capable of producing a screen with stock/futures trading times and prices on a horizontal axis and on a vertical axis, and arranging CRIs (Cells for Recording Stock/Futures Trading Information) corresponding to stock/futures trading times and prices in a matrix configuration on the screen; and a computing module capable of generating an ST (Stock/Futures Trading Information Relation Graph Tag) conforming to stock/futures trading information by stock/futures trading times and prices, inputting the generated ST into the CRIs, and inducing the display of stock/futures trading information by stock/futures trading times and prices.

### TECHNICAL FIELD

This disclosure relates to an apparatus for processing a stock/futures trades status as graphics, and more particularly, to an apparatus for processing a stock/futures trades status in which a computing module capable of obtaining various stock/futures trades information about a stock/futures trades status for each stock/futures trading time zone and each stock/futures trading price range, a computing module capable of configuring a screen so that a stock/futures trading time and a stock/futures trading price respectively represent a horizontal axis and a vertical axis and capable of arranging a Cell for Recording a stock/futures trades Information (hereinafter, referred to as a “CRI”) corresponding to the stock/futures trading time and the stock/futures trading price in the screen in a matrix format, a computing module capable of generating a Stock/futures trades information relation graph Tag (hereinafter, referred to as a “ST”) corresponding to the stock/futures trades information for each stock/futures trading time zone and each stock/futures trading price range and capable of guiding the stock/futures trades information for each stock/futures trading time zone and each stock/futures trading price range to be displayed by inserting the generated ST into the CRI, or the like are systematically linked and disposed in a communication pipeline of an exchange system, which maximizes the visual readability of the stock/futures trades information corresponding to the stock/futures trades status and guides a person in charge at a stock exchange to recognize the change of the stock/futures trades information for each stock/futures trading time zone and each stock/futures trading price range in a lump without any difficulty so that, for example, movements of unfair speculative forces may be more easily monitored and exposed to minimize the damage of clients caused by the deterioration of the stock/futures trades status monitoring/managing quality.

### BACKGROUND ART

As the economic size rapidly expands recently, the number of customers (individual customers, stock firms, or the like) participating in stock/futures trades tends to be rapidly increasing. Accordingly, the social importance of stock/futures exchanges which manage and handle the overall stock/futures trades status of customers is also greatly increasing.

Generally, under such a system, as shown in FIG. 1, an exchange system 1 generally computes stock/futures trades statuses performed at a stock/futures exchange S, and if an asking price data H of a customer is transmitted or received, for example, based on a series of trades principles such as a principle of priority of best quotation and a principle of priority in receipt time, the exchange system 1 performs a procedure of putting each asking price data H for competition so that an asking price data H where several conditions such as price and amount are in full accord is determined as a price for both trading parties. After that, the exchange system 1 takes a series of measures for transmitting a stock/futures trading result detail (for example, conclusion of a trades, trades details, or the like) containing the corresponding determination result to the customer.

Under the situation where a series of stock/futures trades are performed through the stock/futures exchange S, in a case where a series of <stock/futures trades status monitoring/managing procedures> by the stock/futures exchange S is not smoothly performed, a serious problem may occur, and for example, the stock/futures trades market may be seriously distorted by unfair speculative forces. Therefore, the exchange system 1 frequently generates a stock/futures trades status documentary material M (a hardcopy file or a softcopy file) containing a stock/futures trades status (for example, a stock/futures order (asking price) situation, a stock/futures trades situation, an order (asking price), an order (asking price) accumulation situation, trades accumulation situation, or the like), and rapidly provides the generated stock/futures trades status documentary material M to a person in charge at the stock exchange D, so that the person in charge at the stock exchange D is guided to opportunely monitor and manage various stock/futures trades statuses performed at the stock/futures exchange S.

At this time, since the stock/futures trades at the stock/futures exchange S is performed under complicated buying/selling contractions associated with buying customers and selling customers and since the stock/futures trades status frequently changes according to a stock/futures trading time, a stock/futures trading price or the like, the stock/futures exchange documentary material M (a hardcopy file or a softcopy file) generated and provided by the exchange system 1 always has massive information inevitably.

However, despite such situations, the general exchange system 1 recklessly provides the stock/futures trades status documentary material M (a hardcopy file or a softcopy file) containing a stock/futures trades status in a traditional format such as tables and texts with deteriorated <visual readability> without any supplementary measure. Therefore, under the above system, although a person in charge at a stock exchange D normally receives and examines the stock/futures trades status documentary material M, it is very difficult to rapidly grasp the stock/futures trades status, and as a result, the stock/futures trades status monitoring/managing quality of the person in charge at the stock exchange D is greatly deteriorated.

Under the situation where the stock/futures trades status documentary material M has deteriorated visual readability, in a case where the person in charge at the stock exchange D does not accurately recognize or grasp movements of unfair speculative forces by a momentary mistake, the stock/futures trades market will be seriously distorted due to the unfair speculative forces, and as a result, the damage will be widely transferred to general customers with good will.

If any separate measure is not taken under the situation where various problems described above are present, some individual customers will have extremely defensive behaviors in participating in the stock/futures trades market, and stock/futures exchanges and stock firms will suffer from great decrease of the overall stock/futures trades market.

### DISCLOSURE

### Technical Problem

This disclosure is directed to providing an apparatus for processing a stock/futures trades status in which a computing module capable of obtaining various stock/futures trades information (for example, stock bid price quantity information, stock bid residual quantity information, stock offer price quantity information, stock offer residual quantity information, stock offer settlement quantity information, stock bid settlement quantity information, account information, bid price type information, bid price information, bid price quantity information, bid residual quantity information, bid price change information, bid settlement type information, bid settlement price information, bid settlement quantity information, offer price type information, offer price information, offer price quantity information, offer residual quantity information, offer price change information, offer settlement type information, offer settlement price information, offer settlement quantity information, or the like) containing a stock/futures trades status (for example, a stock/futures order (asking price) situation, a stock/futures trades situation, order (asking price) change situation, an order (asking price) accumulation situation, a settlement accumulation situation, or the like) for each stock/futures trading time zone and each stock/futures trading price range; a computing module capable of configuring a screen so that a stock/futures trading time and a stock/futures trading price respectively represent a horizontal axis and a vertical axis and capable of arranging a Cell for Recording a stock/futures trades Information (CRI) corresponding to the stock/futures trading time and the stock/futures trading price in the screen in a matrix format; a computing module capable of generating a Stock/futures trades information relation graph Tag (ST) corresponding to the stock/futures trades information (for example, stock bid price quantity information, stock bid residual quantity information, stock offer price quantity information, stock offer residual quantity information, stock offer settlement quantity information, stock bid settlement quantity information, account information, bid price type information, bid price information, bid price quantity information, bid residual quantity information, bid price change information, bid settlement type information, bid settlement price information, bid settlement quantity information, offer price type information, offer price information, offer price quantity information, offer residual quantity information, offer price change information, offer settlement type information, offer settlement price information, offer settlement quantity information, or the like) for each stock/futures trading time zone and each stock/futures trading price range and capable of guiding the stock/futures trades information for each stock/futures trading time zone and each stock/futures trading price range to be displayed by inserting the generated ST into the CRI; or the like are systematically linked and disposed in a communication pipeline of an exchange system, which maximizes the visual readability of the stock/futures trades information corresponding to the stock/futures trades status and guides a person in charge at a stock exchange to recognize the change of the stock/futures trades information for each stock/futures trading time zone and each stock/futures trading price range in a lump without any difficulty so that, for example, movements of unfair speculative forces may be more easily monitored and exposed to minimize the damage of clients caused by the deterioration of the stock/futures trades status monitoring/managing quality.

Other objects of the present disclosure will be more apparent from the following detailed description and accompanying drawings.

### Technical Solution

In one general aspect, there is provided an apparatus for processing a stock/futures trades status, including: a stock/futures trades status graphics processing control module attached to a stock exchange terminal communicating with an exchange system that computes a stock/futures trades status or attached in the exchange system to generally control a procedure of processing the stock/futures trades status by graphics; a stock/futures trades information obtaining module controlled by the stock/futures trades status graphics processing control module and communicating with the exchange system to obtain stock/futures trades information containing the stock/futures trades status for each stock/futures trading time zone and each stock/futures trading price range; a screen configuring module controlled by the stock/futures trades status graphics processing control module to configure a screen so that a stock/futures trading time and a stock/futures trading price respectively represent a horizontal axis and a vertical axis, and to arrange a Cell for Recording a stock/futures trades Information (CRI) in a matrix format in the screen to correspond to the stock/futures trading time and the stock/futures trading price; and a Stock/futures trades information relation graph Tag (ST) display module controlled by the stock/futures trades status graphics processing control module and communicating with the stock/futures trades information obtaining module to obtain the stock/futures trades information for each stock/futures trading time zone and each stock/futures trading price range, then to generate a ST corresponding to the obtained stock/futures trades information for each stock/futures trading time zone and each stock/futures trading price range, and to display the generated ST in the CRI.

### Advantageous Effects

In the present disclosure, a computing module capable of obtaining various stock/futures trades information about a stock/futures trades status for each stock/futures trading time zone and each stock/futures trading price range, a computing module capable of configuring a screen so that a stock/futures trading time and a stock/futures trading price respectively represent a horizontal axis and a vertical axis and capable of arranging a Cell for Recording a stock/futures trades Information (CRI) corresponding to the stock/futures trading time and the stock/futures trading price in the screen in a matrix format, a computing module capable of generating a Stock/futures trades information relation graph Tag (ST) corresponding to the stock/futures trades information for each stock/futures trading time zone and each stock/futures trading price range and capable of guiding the stock/futures trades information for each stock/futures trading time zone and each stock/futures trading price range to be displayed by inserting the generated ST into the CRI, or the like are systematically linked and disposed in a communication pipeline of an exchange system, which maximizes the visual readability of the stock/futures trades information corresponding to the stock/futures trades status. Therefore, under the circumstance where the present disclosure is implemented, a person in charge at a stock exchange may recognize the change of the stock/futures trades information for each stock/futures trading time zone and each stock/futures trading price range in a lump without any difficulty, and, for example, movements of unfair speculative forces may be more easily monitored and exposed, so that the stock/futures trades status monitoring/managing quality provided by the stock/futures exchange may be greatly improved.

### DESCRIPTION OF DRAWINGS

FIG. 1 is a conceptual diagram exemplarily showing a function performing procedure of a general exchange system.

FIG. 2 is a conceptual diagram exemplarily showing an arrangement of an apparatus for processing a stock/futures trades status according to the present disclosure.

FIG. 3 is a conceptual diagram exemplarily showing a detailed configuration of the stock/futures trades status according to the present disclosure.

FIG. 4 is a conceptual diagram exemplarily showing a posting form of an interface frame according to the present disclosure.

FIG. 5 is a conceptual diagram conceptually showing a function performing procedure of a stock/futures trades information obtaining module and a ST display module according to the present disclosure.

FIG. 6 is a conceptual diagram exemplarily showing a function performing procedure of a screen configuring module according to the present disclosure.

FIGS. 7 to 9 are conceptual diagrams exemplarily showing an insert/display pattern in a CRI of a ST according to the present disclosure.

FIG. 10 is a conceptual diagram exemplarily showing a detailed configuration of the ST display module according to the present disclosure.

FIG. 11 is a conceptual diagram exemplarily showing a function performing procedure of a stock/futures trades information reading unit and a CRI location information obtaining unit according to the present disclosure.

FIG. 12 is a conceptual diagram exemplarily showing a function performing procedure of a ST generating unit according to the present disclosure.

FIG. 13 is a conceptual diagram exemplarily showing a function performing procedure of a ST display location obtaining unit in the CRI according to the present disclosure.

FIG. 14 is a conceptual diagram exemplarily showing a function performing procedure of a ST display unit and a ST coloring unit according to the present disclosure.

FIG. 15 is a conceptual diagram exemplarily showing a function performing procedure of a ST supplementary information providing module according to the present disclosure.

FIG. 16 is a conceptual diagram exemplarily showing a detailed configuration of the ST supplementary information providing module according to the present disclosure.

FIG. 17 is a conceptual diagram exemplarily showing a function performing procedure of a stock/futures trades information reading unit according to the present disclosure.

FIG. 18 is a conceptual diagram exemplarily showing a function performing procedure of a ST supplementary information provision request receiving unit and a target ST characteristic information obtaining unit according to the present disclosure.

FIG. 19 is a conceptual diagram exemplarily showing a function performing procedure of a stock/futures trades information obtaining unit for target ST, a ST supplementary information generating unit and a ST supplementary information providing unit according to the present disclosure.

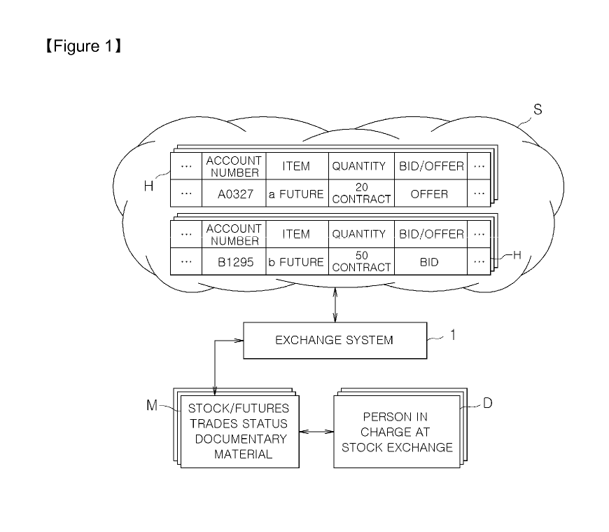

### MODE FOR INVENTION

Hereinafter, an apparatus for processing a stock/futures trades status according to the present disclosure will be described in detail with reference to the accompanying drawings.

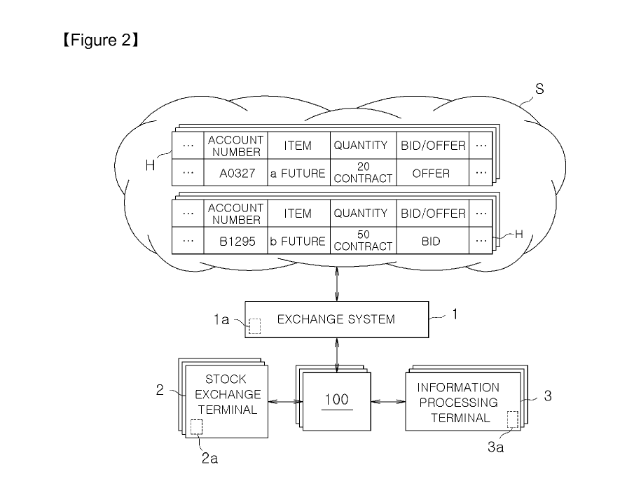

As shown in FIG. 2, under the circumstance where the present disclosure is implemented, an exchange system 1 generally computes stock/futures trades statuses performed at a stock/futures exchange S, and if an asking price data H of a customer is transmitted or received, for example, based on a series of trades principles such as a principle of priority of best quotation and a principle of priority in receipt time, the exchange system 1 performs a procedure of putting each asking price data H for competition so that an asking price data H where several conditions such as price and amount are in full accord is determined as a price for both trading parties. After that, the exchange system 1 takes a series of measures for transmitting a stock/futures trading result detail (for example, conclusion of a trade, trades details, or the like) containing the corresponding determination result to the customer.

Under the situation where a series of stock/futures trades are actively performed through the stock/futures exchange S, in a case where <a stock/futures trades status monitoring/managing procedure> is not smoothly performed, a serious problem may occur, and for example, the stock/futures trades market may be seriously distorted by unfair speculative forces.

In a general case, as described above, in order to prevent such a problem, the exchange system 1 frequently provides a stock/futures trades status documentary material (a hardcopy file or a softcopy file) containing a stock/futures trades status (for example, a stock/futures order (asking price) situation, a stock/futures trades situation, an order (asking price), an order (asking price) accumulation situation, trades accumulation situation, or the like) to a person in charge at the stock exchange, thereby guiding a series of <stock/futures trades status monitoring/managing procedures> to be performed smoothly.

However, since such a general stock/futures trades status documentary material is composed in a traditional format such as tables and texts with deteriorated <visual readability>, although a person in charge at a stock exchange normally receives and examines the stock/futures trades status documentary material, it is very difficult to rapidly grasp the stock/futures trades status.

In this situation, in the present disclosure, it is conceived that a stock/futures trades status processing apparatus 100 is additionally installed to an exchange system 1, or a stock exchange terminal 2 capable of communicating with the exchange system 1, further an external information processing terminal 3 capable of communicating with the exchange system 1.

In this case, for example, computing devices such as notebook PC, desktop PC or the like and mobile devices such as cellular phones, Personal Communications Services (PCS) phones, synchronous/asynchronous International Mobile Telecommunication-2000 (IMT-2000), Palm Personal Computer (PPC), personal digital assistant (PDA), smart phones, Wireless Application Protocol (WAP) phones, play-stations or the like may be variously selected as the stock exchange terminal 2 or the external information processing terminal 3 according to the situation of the person in charge at the stock exchange.

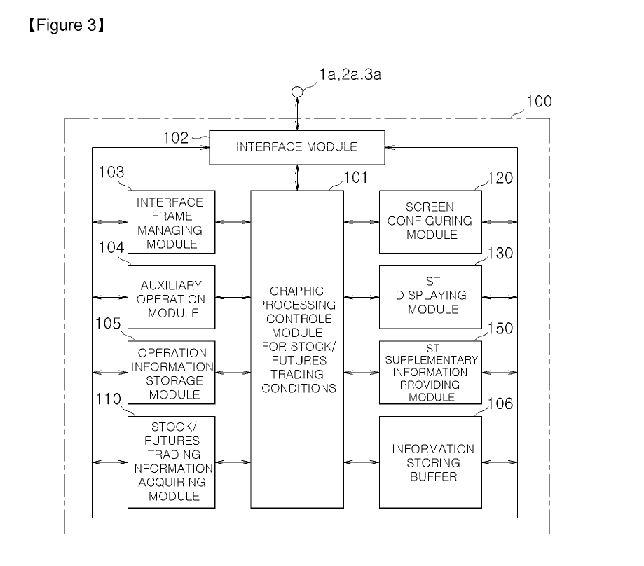

At this time, as shown in FIG. 3, the stock/futures trades status processing apparatus 100 according to the present disclosure is configured to communicate with an operating system 1a of the exchange system 1, an operating system 2a of the stock exchange terminal 2, further, an operating system 3a of the external information processing terminal 3 or the like via an interface module 102 and is also configured so that a graphic processing control module for stock/futures trading conditions 101 for generally controlling <a procedure of processing a stock/futures trades status by graphics>, and an interface frame managing module 103, an auxiliary operation module 104, an operation information storage module 105, a stock/futures trading information acquiring module 110, a screen configuring module 120, a ST display module 130, a ST supplemental information providing module 150 or the like under the control of the graphic processing control module for stock/futures trading conditions 101 are conjunctly combined.

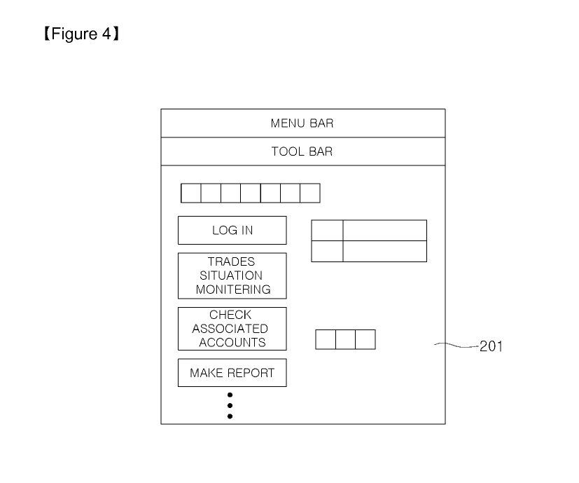

Here, the operation information storage module 105 controlled by the graphic processing control module for stock/futures trading conditions 101 plays a role of stably storing and managing various operating information required for a graphic processing service, for example, various source information (text information, image information, font information, setting information, component information, link information or the like) for generating an interface frame 201 (see FIG. 4), registration information of the person in charge at the stock exchange, registration information of the exchange system 1, registration information of the stock exchange terminal 2, registration information of the external information processing terminal 3, resource condition information of the apparatus 100, component information required for performing a computing process of each computing module in the apparatus 100 or the like in its information storing region (the kind or range of each operating information listed above may be flexibly added, deleted or changed according to the situation of the apparatus 100).

At this time, the auxiliary operation module 104 controlled by the graphic processing control module for stock/futures trading conditions 101 performs various operation assisting procedures required for performing a graphic processing service, for example, a procedure of managing an apparatus logging-in process of the person in charge at the stock exchange, a procedure of configuring/maintaining communication environments with outer systems 1,2 and 3, a procedure of updating/managing accumulation information in the operation information storage module 105 or the like in various ways.

Here, in a case where the person in charge at the stock exchange manipulates the exchange system 1, the stock exchange terminal 2, the external information processing terminal 3 or the like to demand activation of the stock/futures trades status processing apparatus 100, the interface frame managing module 103 controlled by the graphic processing control module for stock/futures trading conditions 101 performs a procedure of accessing the operation information storage module 105 to flexibly extract various text/image/picture/link/program information in order to generate various operation assisting information stored therein, for example, an on-line document, generating an interface frame 201 as shown in FIG. 4 based on each extracted operating information, and posting the generated interface frame 201 through the exchange system 1, the stock exchange terminal 2, the external information processing terminal 3 or the like, so that the basic environment of various graphic processing procedures by the stock/futures trades status processing apparatus 100 may be easily configured without any special problem.

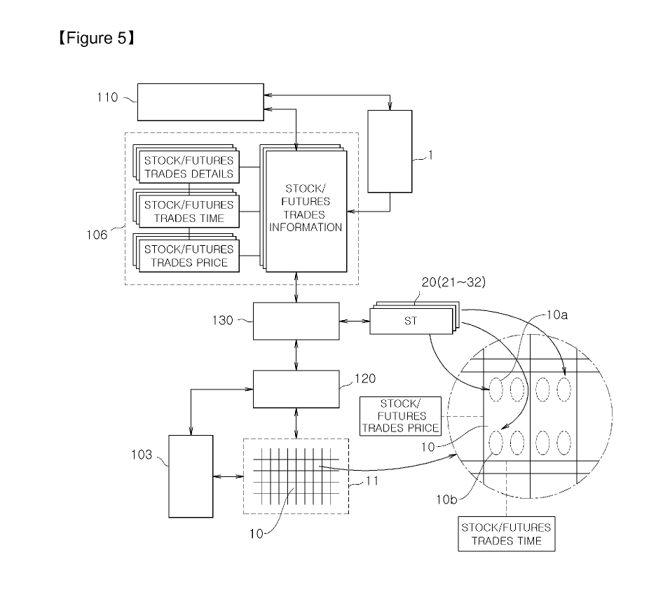

In a situation where such a basic infrastructure is provided, as shown in FIG. 5, the stock/futures trading information acquiring module 110 controlled by the graphic processing control module for stock/futures trading conditions 101 forms a series of communication connection relations with the exchange system 1 via the interface module 102 and plays a role of obtaining stock/futures trades information (for example, stock bid price quantity information, stock bid residual quantity information, stock offer price quantity information, stock offer residual quantity information, stock offer settlement quantity information, stock bid settlement quantity information, account information, bid price type information, bid price information, bid price quantity information, bid residual quantity information, bid price change information, bid settlement type information, bid settlement price information, bid settlement quantity information, offer price type information, offer price information, offer price quantity information, offer residual quantity information, offer price change information, offer settlement type information, offer settlement price information, offer settlement quantity information or the like) containing a stock/futures trades status (for example, a stock/futures order (asking price) situation, a stock/futures trades situation, an order (asking price) change situation, an order (asking price) accumulation situation, a settlement accumulation situation or the like) for each stock/futures trading time zone and each stock/futures trading price range, and then stably storing and managing the obtained stock/futures trades information in a information storing buffer 106 (details of the stock/futures trades status and the stock/futures trades information are just examples for detailed description of the present disclosure, and such stock/futures trades details may be modified in various ways according to the situation).

In this case, in the stock/futures trades information obtained by the stock/futures trading information acquiring module 110, for example, stock/futures trades details such as details associated with a stock bid price situation (for example, a stock bid price quantity, details of a customer making a bid order, account details of a customer making a bid order or the like), details associated with a stock bid residual situation (for example, a stock bid residual quantity, details of a customer making a bid order, account details of a customer making a bid order or the like), details associated with a stock offer price situation (for example, a stock offer price quantity, details of a customer making an offer order, account details of a customer making an offer order or the like), details associated with a stock offer residual situation (for example, a stock offer residual quantity, details of a customer making an offer order, account details of a customer making an offer order or the like), details associated with a stock offer situation (for example, a stock offer settlement quantity, details of a customer whose offer is settled, account details of a customer whose offer is settled or the like), details associated with a stock bid situation (for example, a stock bid settlement quantity, details of a customer whose bid is settled, account details of a customer whose bid is settled or the like) or the like as well as a stock/futures trading time when the stock/futures trades is performed (or, when the stock/futures trades is proposed) and a stock/futures trading price when the stock/futures trades is performed (or, when the stock/futures trades is proposed) are recorded (the stock/futures trades details described above are also just examples for detailed description of the present disclosure, and such stock/futures trades details may be modified in various ways according to the situation).

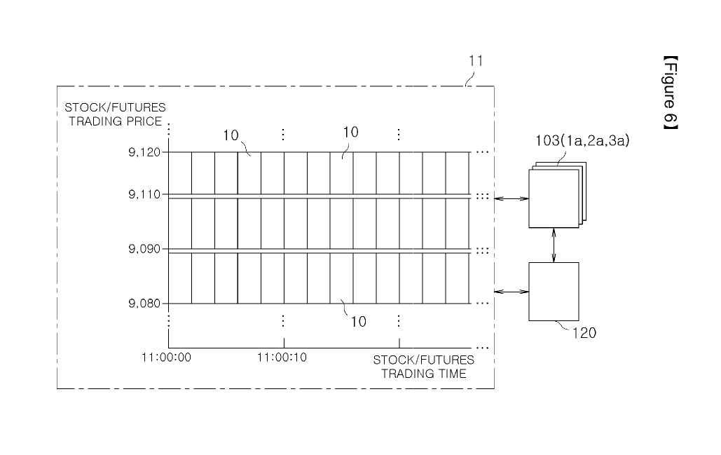

Meanwhile, in a case where the person in charge at the stock exchange selects <a menu item associated with the graphic processing of the stock/futures trades status> posted in the interface frame 201, together with the stock/futures trading information acquiring module 110, as shown in FIG. 6, the screen configuring module 120 controlled by the graphic processing control module for stock/futures trading conditions 101 communicates with the interface frame managing module 103 and each operating system 1a, 2a and 3a and performs a procedure of configuring a screen 11 by utilizing various component information stored in the operation information storage module 105 so that the stock/futures trading time and the stock/futures trading price respectively represent a horizontal axis (the abscissa axis) and a vertical axis (the ordinate axis) and arranging a CRI 10 in a matrix format in the screen 11 to correspond to the stock/futures trading time and the stock/futures trading price.

As a result, while the screen configuring module 120 functions as above, in a rectangular coordinate system composed of stock/futures trading time coordinates and stock/futures trading price coordinates, each CRI 10 arranged in the screen 11 takes the form of occupying upper, lower, right and left portions of each crossing point of the coordinates.

Meanwhile, in a state where the screen 11 and the CRI 10 are configured, displayed and maintained through the above procedure, as shown in FIG. 5, the ST displaying module 130 controlled by the graphic processing control module for stock/futures trading conditions 101 communicates with the stock/futures trading information acquiring module 110, the information storing buffer 106 or the like to obtain the stock/futures trades information for each stock/futures trading time zone and each stock/futures trading price range and then perform a series of data generating routines, so that a ST 20 (the form of the ST may be variously modified according to the situation) having, for example, a bar graph form corresponding to the obtained stock/futures trades information for each stock/futures trading time zone and each stock/futures trading price range is generated, and the ST displaying module 130 communicates with the screen configuring module 120, the interface frame managing module 103 or the like to perform a procedure of inserting the generated ST 20 into designated display locations 10a and 10b in the CRI 10 and displaying it.

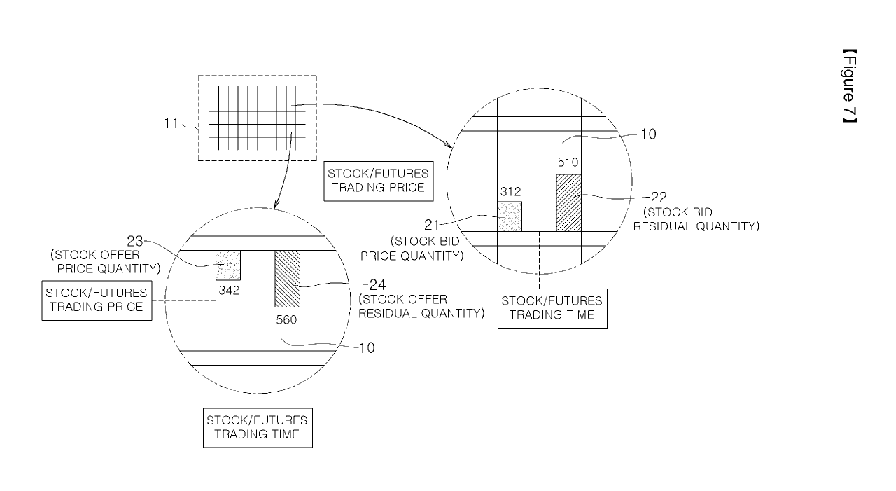

While the ST displaying module 130 functions as described above, for example, as shown in FIG. 7, a ST 21 having a bar graph form meaning <the bid price quantity information corresponding to the target stock/futures trading time and the target stock/futures trading price> is inserted and displayed at a left lower edge of a target CRI 10 corresponding to a specific target stock/futures trading time coordinate and target stock/futures trading price coordinate, and a ST 22 having a bar graph form meaning <the bid residual quantity information corresponding to the target stock/futures trading time and the target stock/futures trading price> is inserted and displayed at a right lower edge of the target CRI 10.

In addition, as shown in FIG. 7, while the ST displaying module 130 functions, a ST 23 having a bar graph form meaning <the offer price quantity information corresponding to the target stock/futures trading time and the target stock/futures trading price> is inserted and displayed at a left upper edge of the target CRI 10 corresponding to a specific target stock/futures trading time coordinate and target stock/futures trading price coordinate, and a ST 24 having a bar graph form meaning <the offer residual quantity information corresponding to the target stock/futures trading time and the target stock/futures trading price> is inserted and displayed at a right upper edge of the target CRI 10.

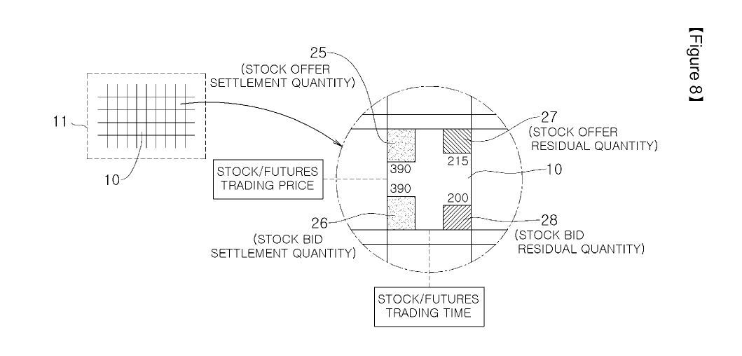

In addition, as shown in FIG. 8, while the ST displaying module 130 functions, a ST 25 having a bar graph form meaning <the offer settlement quantity information corresponding to the target stock/futures trading time and the target stock/futures trading price> is inserted and displayed at a left upper edge of the target CRI 10 corresponding to a specific target stock/futures trading time coordinate and target stock/futures trading price coordinate of the screen 11, a ST 27 having a bar graph form meaning <the offer residual quantity information corresponding to the target stock/futures trading time and the target stock/futures trading price> is inserted and displayed at a right upper edge of the target CRI 10, a ST 26 having a bar graph form meaning <the bid settlement quantity information corresponding to the target stock/futures trading time and the target stock/futures trading price> is inserted and displayed at a right lower edge of the target CRI 10, and a ST 28 having a bar graph form meaning <the bid residual quantity information corresponding to the target stock/futures trading time and the target stock/futures trading price> is inserted and displayed at a right lower edge of the target CRI 10.

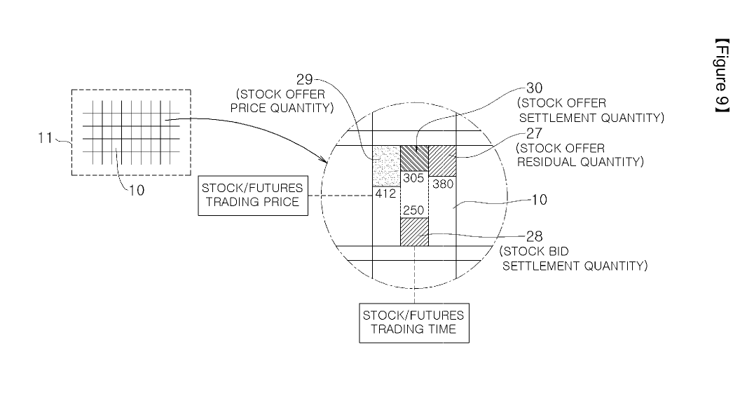

Further, as shown in FIG. 9, while the ST displaying module 130 functions, a ST 29 having a bar graph form meaning <the offer price quantity information corresponding to the target stock/futures trading time and the target stock/futures trading price> is inserted and displayed at a left upper edge of the target CRI 10 corresponding to a specific target stock/futures trading time coordinate and target stock/futures trading price coordinate of the screen 11, a ST 31 having a bar graph form meaning <the offer residual quantity information corresponding to the target stock/futures trading time and the target stock/futures trading price> is inserted and displayed at a right upper edge of the target CRI 10, a ST 30 having a bar graph form meaning <the offer settlement quantity information corresponding to the target stock/futures trading time and the target stock/futures trading price> is inserted and displayed at an upper center of the target CRI 10, and a ST 32 having a bar graph form meaning <the bid settlement quantity information corresponding to the target stock/futures trading time and the target stock/futures trading price> is inserted and displayed at a lower center of the target CRI 10.

In the case where the ST 20 corresponding to the stock/futures trades information for each stock/futures trading time zone and each stock/futures trading price range is inserted and displayed at the inside of the CRI 10 taking the form of occupying upper, lower, right and left portions of each crossing point of coordinates in a rectangular coordinate system composed of stock/futures trading time coordinates and stock/futures trading price coordinates as described above, the person in charge at the stock exchange monitoring the screen 11 and the CRI 10 through the exchange system 1, the stock exchange terminal 2, the external information processing terminal 3 or the like may grasp the change of the stock/futures trades information for each stock/futures trading time zone and each stock/futures trading price range in a lump by means of the display pattern of the ST 20.

Since the ST 20 may provide a very excellent <visual readability> by adopting a visual graphic image such as a bar graph or the like, different from a traditional display format such as tables and texts, under the environment where the present disclosure is implemented, a person in charge at the stock exchange may more easily monitor and expose movements or the like of, for example, unfair speculative forces while grasping the change of the stock/futures trades information for each stock/futures trading time zone and each stock/futures trading price range in a lump without any readability defect (namely, without any visual inconvenience), and as a result each customer participating in the stock/futures trades may effectively enjoy the advantage according to the improvement of the stock/futures trades status monitoring/managing quality.

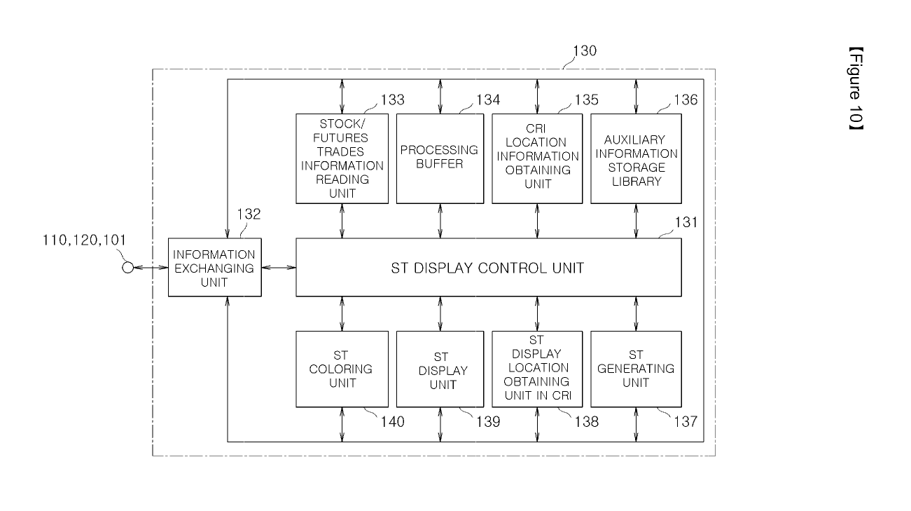

At this time, as shown in FIG. 10, the ST displaying module 130 according to the present disclosure is configured so that a ST display control unit 131 for generally controlling an overall ST display procedure as well as a stock/futures trades information reading unit 133, a CRI location information obtaining unit 135, a ST generating unit 137, a ST display location obtaining unit 138 in the CRI, a ST display unit 139, a ST coloring unit 140 or the like controlled by the ST display control unit 131 are conjunctly combined.

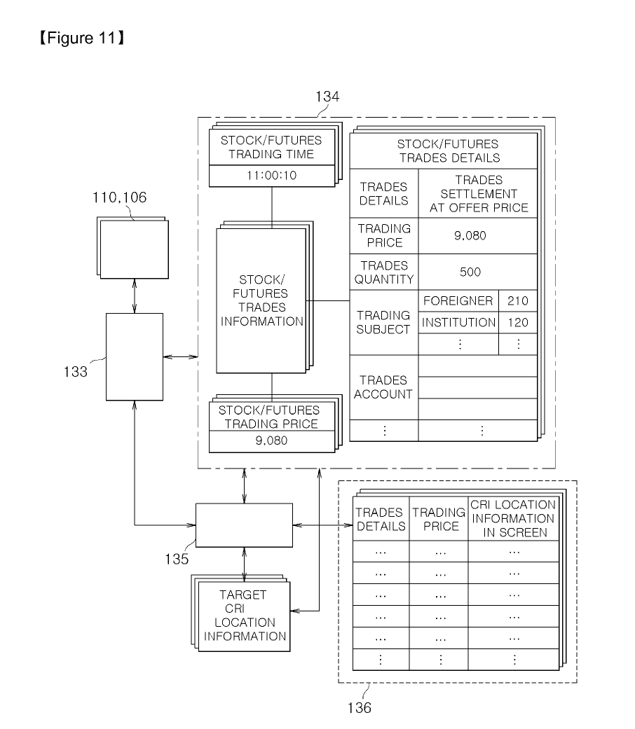

Here, as shown in FIG. 11, the stock/futures trades information reading unit 133 communicates with the stock/futures trading information acquiring module 110, the information storing buffer 106 or the like via the information exchanging unit 132, and plays a role of reading the stock/futures trades information containing a stock/futures trades status (for example, a stock/futures order (asking price) situation, a stock/futures trades situation, an order (asking price) change situation, an order (asking price) accumulation situation, a settlement accumulation situation or the like) for each stock/futures trading time zone and each stock/futures trading price range, and then stably storing and managing the read stock/futures trades information in the processing buffer 134.

As described above, in the stock/futures trades information read and obtained by the stock/futures trades information reading unit 133, for example, stock/futures trades details such as details associated with a stock bid price situation (for example, a stock bid price quantity, details of a customer making a bid order, account details of a customer making a bid order or the like), details associated with a stock bid residual situation (for example, a stock bid residual quantity, details of a customer making a bid order, account details of a customer making a bid order or the like), details associated with a stock offer price situation (for example, a stock offer price quantity, details of a customer making an offer order, account details of a customer making an offer order or the like), details associated with a stock offer residual situation (for example, a stock offer residual quantity, details of a customer making an offer order, account details of a customer making an offer order or the like), details associated with a stock offer situation (for example, a stock offer settlement quantity, details of a customer whose offer is settled, account details of a customer whose offer is settled or the like), details associated with a stock bid situation (for example, a stock bid settlement quantity, details of a customer whose bid is settled, account details of a customer whose bid is settled or the like) or the like as well as a stock/futures trading time when the stock/futures trades is performed (or, when the stock/futures trades is proposed) and a stock/futures trading price when the stock/futures trades is performed (or, when the stock/futures trades is proposed) are recorded (see FIG. 11).

By doing so, in a situation where the stock/futures trades information is read and stored in the processing buffer 134, as shown in FIG. 11, the CRI location information obtaining unit 135 performs a procedure of confirming specific stock/futures trades information whose visualization is demanded, among the stock/futures trades information read by the stock/futures trades information reading unit 133 (this confirming procedure may be performed, for example, in an obtaining order of the stock/futures trades information).

Under this procedure, a process where, among the stock/futures trades information read by the stock/futures trades information reading unit 133, for example, the stock/futures trades information having <trades settlement at the offer price> as its stock/futures trades details is confirmed to be <specific stock/futures trades information whose visualization is demanded> (see FIG. 11).

By doing so, if the stock/futures trades information having <trades settlement at the offer price> as its stock/futures trades details is confirmed to be <specific stock/futures trades information whose visualization is demanded>, the CRI location information obtaining unit 135 performs a procedure of grasping the target stock/futures trading time and the stock/futures trading price recorded in the confirmed specific stock/futures trades information.

Under such a procedure, a process in which a stock/futures trading time <11:00:10> and a stock/futures trading price <9,080> recorded in the stock/futures trades information having <trades settlement at the offer price> as its stock/futures trades details are grasped as the target stock/futures trading time and the target stock/futures trading price required for obtaining the CRI location information (see FIG. 11).

By doing so, if the stock/futures trading time <11:00:10> and the stock/futures trading price <9,080> recorded in the specific stock/futures trades information are completely grasped as the target stock/futures trading time and the target stock/futures trading price, the CRI location information obtaining unit 135 compares the grasped target stock/futures trading time and stock/futures trading price (namely, the stock/futures trading time <11:00:10> and the stock/futures trading price <9,080>) with <index data defining CRI location information for each stock/futures trading time zone and each stock/futures trading price range> stored in an auxiliary information storage library 136 to perform a procedure of obtaining target CRI location information corresponding to the target stock/futures trading time and stock/futures trading price (namely, the stock/futures trading time <11:00:10> and the stock/futures trading price <9,080>).

In this case, in the <index data defining CRI location information for each stock/futures trading time zone and each stock/futures trading price range>, for example, various index information such as <CRI location in the screen corresponding to stock/futures trading time (coordinate)/stock/futures trading price (coordinate) 11:01:01/9,050 is XX> and <CRI location in the screen corresponding to stock/futures trading time (coordinate)/stock/futures trading price (coordinate) 11:01:20/9,090 is XX> is recorded in various ways, and as a result, under the procedure where the index data are compared and searched, the CRI location information obtaining unit 135 refers to the information <CRI location in the screen corresponding to stock/futures trading time (coordinate)/stock/futures trading price (coordinate) 11:00:10/9,080 is XX> among several information recorded in the index data, so that the target CRI location information corresponding to the target stock/futures trading time and stock/futures trading price (namely, the stock/futures trading time <11:00:10> and the stock/futures trading price <9,080>) may be easily obtained.

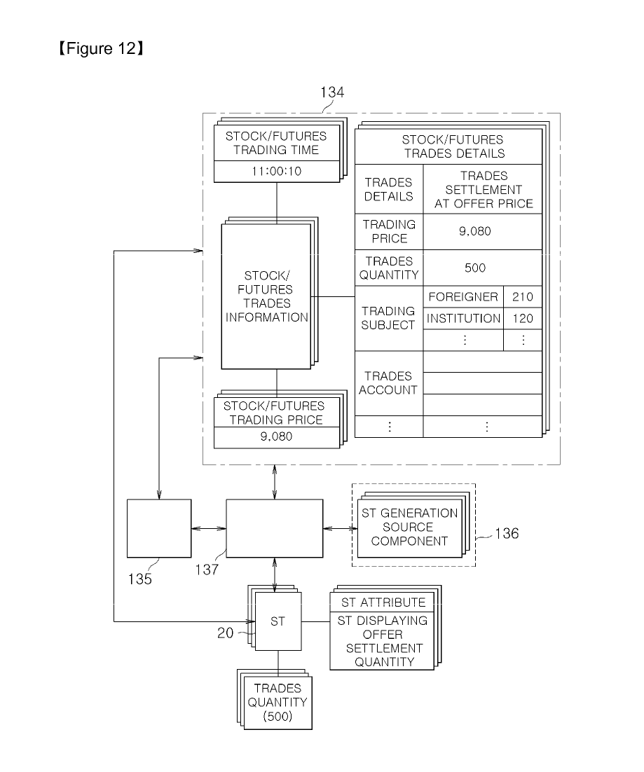

Meanwhile, in a situation where the CRI location information obtaining unit 135 functions to obtain the target CRI location information, as shown in FIG. 12, the ST generating unit 137 communicates with the CRI location information obtaining unit 135 to perform a procedure of confirming, for example, the stock/futures trades information having <trades settlement at the offer price> as its stock/futures trades details to be <specific stock/futures trades information whose visualization is demanded>, among the stock/futures trades information read by the stock/futures trades information reading unit 133.

By doing so, if the stock/futures trades information having <trades settlement at the offer price> as its stock/futures trades details is confirmed to be <specific stock/futures trades information whose visualization is demanded>, the ST generating unit 137 communicates with the processing buffer 134 to perform a procedure of grasping the target stock/futures trades details recorded in the confirmed specific stock/futures trades information.

Under this procedure, a process where <details associated with a stock offer situation (for example, a stock offer settlement quantity, details of a customer whose offer is settled, account details of a customer whose offer is settled or the like)> recorded in the specific stock/futures trades information is grasped as target stock/futures trades details required for generating the ST is performed (see FIG. 12).

By doing so, if the <details associated with a stock offer situation (for example, a stock offer settlement quantity, details of a customer whose offer is settled, account details of a customer whose offer is settled or the like)> recorded in the specific stock/futures trades information is completely grasped as target stock/futures trades details required for generating the ST, the ST generating unit 137 refers to the target stock/futures trades details, namely <details associated with a stock offer situation (for example, a stock offer settlement quantity, details of a customer whose offer is settled, account details of a customer whose offer is settled or the like)>, so that the target ST 20 and target ST attribute information corresponding thereto are combined and generated.

Under a situation where the above role is performed, as shown in FIG. 12, the ST generating unit 137 performs a series of data generating routine by utilizing ST generation source components (for example, a graphic component, a skin component, a program component, a modification component or the like) stored in the auxiliary information storage library 136 to perform a procedure of generating the ST having a bar graph form with a size corresponding to a stock offer settlement quantity 500 (namely, a trades volume 500) together with <number 500> (here, the size of the generated bar graph may increase or decrease according to the size of the trades volume), performs a series of data generating routine utilizing <details associated with a stock offer situation> recorded in the specific stock/futures trades information to perform a procedure of generating ST attribute information to the effect that <the ST presently generated is a ST displaying the offer settlement quantity>, and later performs a series of data coupling routine to perform a procedure of coupling both generated data into a single data.

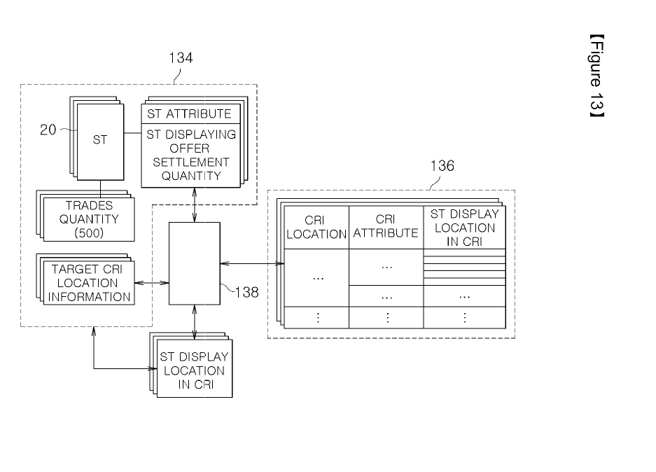

Meanwhile, in a situation where the target CRI location information, the ST, the ST attribute information or the like are completely generated and obtained through the above procedure, as shown in FIG. 13, the ST display location obtaining unit 138 in the CRI communicates with the processing buffer 134 to perform a procedure of securing the target CRI location information and target ST attribute information obtained and generated by the CRI location information obtaining unit 135 and the ST generating unit 137, and then comparing the secured target CRI location information and target ST attribute information with <index data defining a ST display location of each ST attribute corresponding to the CRI location> stored in the auxiliary information storage library 136, so that the target ST 20 obtains the <target ST display location information in the CRI>.

In this case, in the <index data defining a ST display location of each ST attribute corresponding to the CRI location>, for example, various index information such as <the ST display location in the CRI corresponding to the CRI location XX and in accordance with the ST having an attribute displaying a bid residual quantity is a coordinate XXX corresponding to the right lower edge of the CRI>, <the ST display location in the CRI corresponding to the CRI location XX and in accordance with the ST having an attribute displaying a bid price quantity is a coordinate XXX corresponding to the left lower edge of the CRI> are recorded in various ways (see FIG. 13), and as a result, under a procedure where the index data are compared and searched, the ST display location obtaining unit 138 in the CRI refers to <the ST display location in the CRI corresponding to the CRI location XX and in accordance with the ST having an attribute displaying an offer settlement quantity is a coordinate XXX corresponding to the left upper edge of the CRI> among various information recorded in the index data, so that the target ST 20 may easily obtain <ST display location information in the target CRI> (for example, information notifying that the ST display location in the CRI corresponding to the ST is a coordinate XXX corresponding to the left upper edge of the CRI) to be displayed.

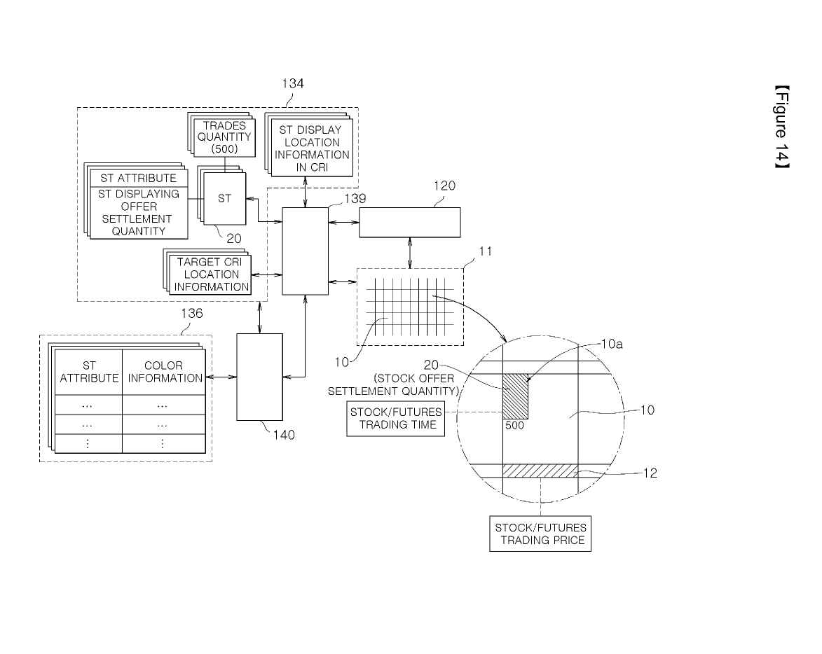

Meanwhile, in a situation where the target CRI location information, the ST, the ST attribute information, the <ST display location information in the target CRI> or the like are completely generated and obtained through the above procedure, as shown in FIG. 14, the ST display unit 139 communicates with the processing buffer 134 to secure the target CRI location information, the ST, the ST attribute information, the <ST display location information in the target CRI> obtained or generated by the CRI location information obtaining unit 135, the ST generating unit 137, the ST display location obtaining unit 138 in the CRI or the like, and communicates with the screen configuring module 120 based on the information notifying <the CRI location in the screen corresponding to the stock/futures trading time (coordinate) and stock/futures trading price (coordinate) which is 11:00:10/9,080 is XX> to perform a procedure of confirming the target CRI 10 where the target ST 20 will be displayed, among the CRI 10 configuring the screen 11.

By doing so, in the CRI 10 configuring the screen 11, if the target CRI 10 where the target ST 20 will be displayed is completely confirmed, the ST display unit 139 communicates with the screen configuring module 120 based on the information notifying <the ST display location in the CRI corresponding to the CRI location XX and in accordance with the ST having an attribute displaying an offer settlement quantity is a coordinate XXX corresponding to the left upper edge of the CRI> displayed in <ST display location information in the target CRI> to perform a procedure of inserting and displaying <stock offer settlement quantity 500 (namely, the ST 20 having a bar graph form with a size corresponding to the trades volume 500)> at a specific location 10a (for example, the left upper edge) in the target CRI 10 together with <number 500> (see FIG. 14).

Under a situation where the above procedure (the procedure of inserting and displaying the ST 20 in each CRI 10) is repeated, the person in charge at the stock exchange may grasp the change of the stock/futures trades information for each stock/futures trading time zone and each stock/futures trading price range in a lump while observing the ST 20 of a bar graph form having very excellent <visual readability> through each CRI 10 as a whole without any readability defect (namely, without any visual inconvenience), and as a result, movements or the like of unfair speculative forces may be more easily monitored and exposed.

Meanwhile, in a situation where the target ST 20 is inserted and displayed at the specific location 10a in the target CRI 10 through the above procedure, as shown in FIG. 14, the ST coloring unit 140 accesses the processing buffer 134 and performs a procedure of checking the attribute information of the target ST 20 generated by the ST generating unit 137 (for example, information notifying <the ST is a ST displaying an offer settlement quantity>, and comparing the corresponding ST attribute information with <index data defining color information of each ST attribute>, so that the target color applied to the target ST 20 or surroundings 12 of the target ST 20 is confirmed.

In this case, in the <index data defining color information of each ST attribute>, for example, various index information such as <apply a blue color to a ST displaying a bid residual quantity>, <apply a green color to a ST displaying a bid settlement quantity and apply a red color to its lower rim> are recorded in various ways (see FIG. 14), and as a result, under a situation where the index data is compared and searched, the ST coloring unit 140 may easily confirm a target color to be applied to the target ST 20 or the surrounding 12 of the corresponding target ST 20 by referring to the information notifying <apply a yellow color to a ST displaying a bid settlement quantity, and apply a red color to its lower rim>.

By doing so, if the target color to be applied to the target ST 20 or the surrounding 12 of the corresponding target ST 20 is completely confirmed, the ST coloring unit 140 performs a series of data generating routine to generate color data such as yellow and red, and communicates with the ST display unit 139 based on the <ST display location information in the target CRI> to perform a procedure of applying a target color (for example, yellow or red) to the target ST 20 or the surrounding 12 of the corresponding target ST 20. As a result, under this procedure, a color such as yellow and red may be stably endowed to the target ST 20 inserted or displayed in the CRI 10 or the surrounding 12 of the corresponding target ST 20.

Under a situation where this procedure (namely, the procedure of endowing a color to the ST or its surrounding) is repeated, the person in charge at the stock exchange may flexibly enjoy the advantage that the visual readability of the ST 20 is further improved, and as a result, movement or the like of unfair speculative forces may be more easily monitored and exposed.

Meanwhile, in a situation where the ST 20 is inserted and displayed in each CRI 10 according to the above procedure, the person in charge at the stock exchange may have a desire <to see more detailed supplementary information (for example, detailed information about a stock/futures trades quantity, detailed information about a stock/futures trading subject, detailed information about a stock/futures trades account or the like) meant by the ST 20>.

In this situation, as shown in FIG. 3, in the present disclosure, a measure of additionally disposing the ST supplemental information providing module 150 under the control system of the graphic processing control module for stock/futures trading conditions 101 is conceived.

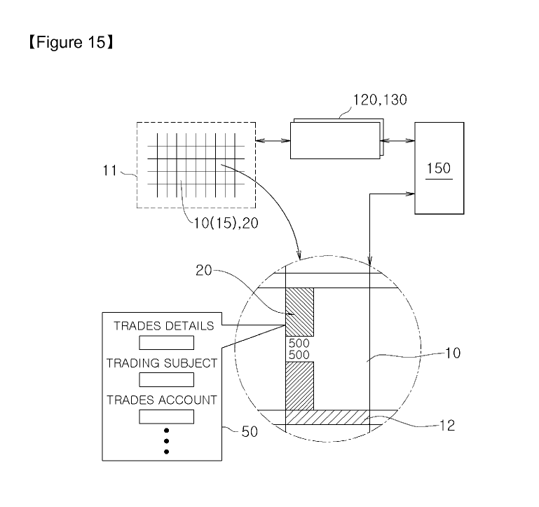

In this case, as shown in FIG. 15, according to the request of the screen configuring module 120 corresponding to a computing work of the person in charge at the stock exchange who requests the ST supplementary information, the ST supplemental information providing module 150 plays a role of reading the stock/futures trades information corresponding to the ST 20 inserted into the CRI 10, then generating ST supplementary information (for example, detailed information about a stock/futures trades quantity, detailed information about a stock/futures trading subject, detailed information about a stock/futures trades account or the like) corresponding to the read stock/futures trades information, and displaying the generated ST supplementary information 50 at a region adjacent to the ST 20.

In a situation where the ST supplementary information 50 is visually displayed, the person in charge at the stock exchange may more easily obtain and check more detailed supplementary information 50 (for example, detailed information about a stock/futures trades quantity, detailed information about a stock/futures trading subject, detailed information about a stock/futures trades account or the like) meant by the ST 20, in addition to the ST 20 having a bar graph form, and as a result, movements or the like of unfair speculative forces may be more easily monitored and exposed.

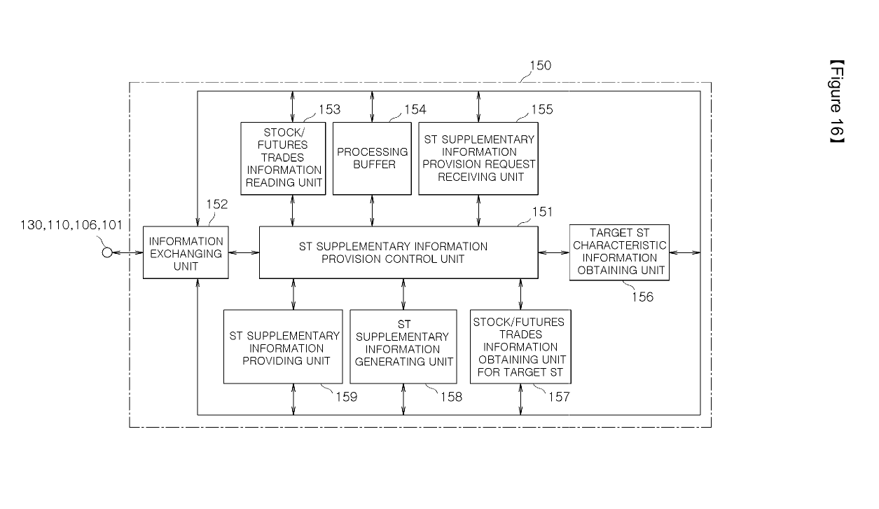

At this time, as shown in FIG. 16, the ST supplemental information providing module 150 according to the present disclosure is configured so that a ST supplementary information provision control unit 151 for generally controlling an overall ST supplementary information providing procedure as well as a stock/futures trades information reading unit 153, a ST supplementary information provision request receiving unit 155, a target ST characteristic information obtaining unit 156, a stock/futures trades information obtaining unit 157 for the target ST, a ST supplementary information generating unit 158, a ST supplementary information providing unit 159 or the like controlled by the ST supplementary information provision control unit 151 are conjunctly combined.

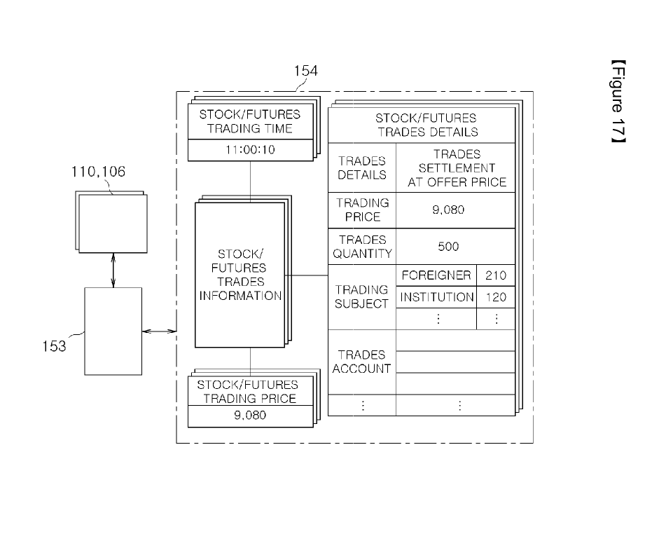

Here, as shown in FIG. 17, the stock/futures trades information reading unit 153 communicates with the stock/futures trading information acquiring module 110, the information storing buffer 106 or the like via the information exchanging unit 152 to read the stock/futures trades information containing a stock/futures trades status (for example, a stock/futures order (asking price) situation, stock/futures trades situation, an order (asking price) change situation, an order (asking price) accumulation situation, a settlement accumulation situation or the like) for each stock/futures trading time zone and each stock/futures trading price range, and then plays a role of stably storing and managing the read stock/futures trades information in the processing buffer 154.

As described above, in the stock/futures trades information read and obtained by the stock/futures trades information reading unit 153, for example, stock/futures trades details such as details associated with a stock bid price situation (for example, a stock bid price quantity, details of a customer making a bid order, account details of a customer making a bid order or the like), details associated with a stock bid residual situation (for example, a stock bid residual quantity, details of a customer making a bid order, account details of a customer making a bid order or the like), details associated with a stock offer price situation (for example, a stock offer price quantity, details of a customer making an offer order, account details of a customer making an offer order or the like), details associated with a stock offer residual situation (for example, a stock offer residual quantity, details of a customer making an offer order, account details of a customer making an offer order or the like), details associated with a stock offer situation (for example, a stock offer settlement quantity, details of a customer whose offer is settled, account details of a customer whose offer is settled or the like), details associated with a stock bid situation (for example, a stock bid settlement quantity, details of a customer whose bid is settled, account details of a customer whose bid is settled or the like) or the like as well as a stock/futures trading time when the stock/futures trades is performed (or, when the stock/futures trades is proposed) and a stock/futures trading price when the stock/futures trades is performed (or, when the stock/futures trades is proposed) are recorded (see FIG. 17).

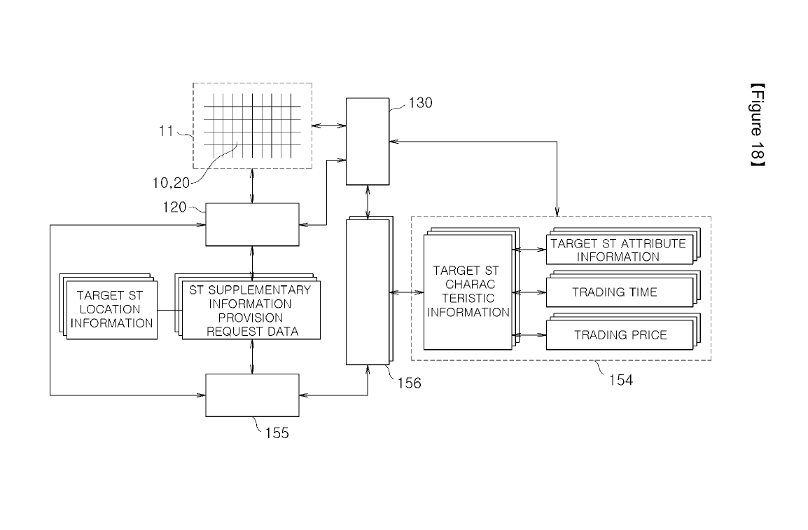

By doing so, in a situation where the stock/futures trades information is read and stored in the processing buffer 154, as shown in FIG. 18, the ST supplementary information provision request receiving unit 155 forms a series of communication relations with the screen configuring module 120 via the information exchanging unit 152, and the person in charge at the stock exchange observing the ST 20 inserted and displayed in each CRI 10 performs a computing work (for example, a computing work for clicking a specific ST) requesting the provision of the ST supplementary information 50. Accordingly, in a case where a series of ST supplementary information provision request data are transmitted from the screen configuring module 120, a role of receiving and processing the corresponding ST supplementary information provision request data via the information exchanging unit 152 is performed.

In this case, in the ST supplementary information provision request data transmitted from the screen configuring module 120, location information (namely, information notifying that the target ST 20 selected by the person in charge at the stock exchange belongs to a XX coordinate of the CRI 10 having a XX coordinate) selected by the person in charge at the stock exchange is recorded together.

Through the above procedure, in a state where the ST supplementary information provision request data is completely received, the target ST characteristic information obtaining unit 156 reads <location information of the target ST selected by the person in charge at the stock exchange (namely, information notifying that the target ST 20 selected by the person in charge at the stock exchange belongs to a XX coordinate of the CRI 10 having a XX coordinate)> recorded in the ST supplementary information provision request data, and performs a procedure of grasping <location of the target ST 20 requesting the provision of supplementary information>.

By doing so, if <location of the target ST 20 requesting the provision of supplementary information> is completely grasped, the target ST characteristic information obtaining unit 156 communicates with the ST displaying module 130 via the information exchanging unit 152 to transmit <location of the target ST 20 requesting the provision of supplementary information>. After that, if <characteristic information of the target ST requesting the provision of supplementary information> is transmitted from the ST displaying module 130 corresponding to <location of the target ST 20 requesting the provision of supplementary information>, a procedure of receiving and obtaining the information is performed.

In this case, in <characteristic information of the target ST 20 requesting the provision of the supplementary information> transmitted and provided from the ST display module 130, <attribute information of the corresponding target ST 20 (for example, attribute information notifying that the corresponding target ST is a ST displaying an offer settlement quantity)>, <stock/futures trading time information associated with the corresponding target ST 20 (for example, offer settlement time information of 11:00:10)>, <stock/futures trading price information associated with the corresponding target ST 20 (for example, offer settlement price information of 9,080)> or the like are recorded in detail.

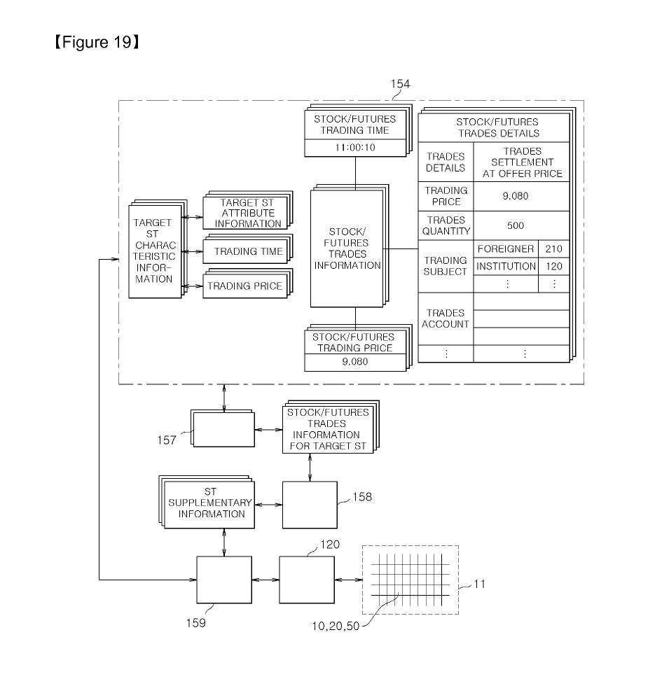

Through the above procedure, if the <characteristic information of the target ST 20 requesting the provision of the supplementary information> is completely obtained, as shown in FIG. 19, the stock/futures trades information obtaining unit 157 for the target ST communicates with the processing buffer 154 to perform a procedure of grasping <attribute information of the target ST 20 (for example, attribute information notifying that the target ST is a ST displaying an offer settlement quantity)>, <stock/futures trading time information associated with the target ST 20 (for example, offer settlement time information of 11:00:10)>, <stock/futures trading price information associated with the target ST 20 (for example, offer settlement price information of 9,080)> or the like recorded in the <characteristic information of the target ST 20 requesting the provision of the supplementary information>.

By doing so, if the <attribute information of the target ST 20 (for example, attribute information notifying that the target ST is a ST displaying an offer settlement quantity)>, <stock/futures trading time information associated with the target ST 20 (for example, offer settlement time information of 11:00:10)>, <stock/futures trading price information associated with the target ST 20 (for example, offer settlement price information of 9,080)> or the like recorded in the <characteristic information of the target ST 20 requesting the provision of the supplementary information> are completely grasped, the stock/futures trades information obtaining unit 157 for the target ST communicates with the processing buffer 154 to perform a procedure of obtaining the stock/futures trades information for the target ST, which corresponds to the target ST 20, among the stock/futures trades information read by the stock/futures trades information reading unit 153.

Under the above procedure, among the stock/futures trades information read by the stock/futures trades information reading unit 153, the <stock/futures trades information having the offer settlement as its stock/futures trades details and having the offer settlement time of 11:00:10 and the offer settlement price of 9,080> is confirmed to be <stock/futures trades information for the target ST> corresponding to the target ST 20, so that a procedure of selecting and obtaining the information by the stock/futures trades information obtaining unit 157 for the target ST is performed.

Through the above procedure, if the <stock/futures trades information having the offer settlement as its stock/futures trades details and having the offer settlement time of 11:00:10 and the offer settlement price of 9,080> is completely confirmed and obtained to be <stock/futures trades information for the target ST> corresponding to the target ST 20, as shown in FIG. 19, the ST supplementary information generating unit 158 performs a series of data generating routine to perform a procedure of generating the ST supplementary information 50 containing, for example, <details such as offer settlement quantity detail information, offer settlement subject detail information, offer settlement trades account detail information or the like> into a format such as tables, texts, pictures or the like by summarizing and transforming the <stock/futures trades information for the target ST> into a report format.

By doing so, if the ST supplementary information 50 containing, for example, details such as offer settlement quantity detail information, offer settlement subject detail information, offer settlement trades account detail information or the like into a format such as tables, texts, pictures or the like is completely generated, the ST supplementary information providing unit 159 communicates with the ST supplementary information generating unit 158 to perform a procedure of obtaining the generated ST supplementary information 50, and reads the <location information of the target ST 20 selected by the person in charge at the stock exchange (namely, information notifying that the target ST 20 selected by the person in charge at the stock exchange belongs to a XX coordinate of the CRI 10 having a XX coordinate)> recorded in the ST supplementary information provision request data to perform a procedure of grasping <location of the target ST 20 requesting the provision of supplementary information>.

Through the above procedure, if the ST supplementary information 50 and the <location of the target ST 20 requesting the provision of supplementary information> are completely grasped, the ST supplementary information providing unit 159 communicates with the screen configuring module 120 to perform a procedure of displaying the ST supplementary information 50 at a region adjacent to the target ST 20 as shown in FIG. 15, and as a result, the person in charge at the stock exchange may check the <more detailed supplementary information 50 meant by the ST 20 (for example, offer settlement quantity detail information, offer settlement subject detail information, offer settlement trades account detail information or the like)> in a format such as pictures, tables, texts or the like, in addition to the ST 20 having a bar graph form.

Even in this case, the quality of the <stock/futures trades status monitoring/managing service> performed by the person in charge at the stock exchange may be greatly improved, and as a result each customer participating in stock/futures trades may flexibly enjoy the advantage accordingly.

The present disclosure described as above generally gives a useful effect at various kinds of computing systems which requires management, observation and monitoring of various events.

In addition, even though specific embodiments of the present disclosure have been described and illustrated, it will be understood by those skilled in the art that various modifications may be made thereto.

Such modifications should not be interpreted separate from the spirit or view of the present disclosure, and such modifications should be interpreted as being included in the scope of the appended claims.

### INDUSTRIAL APPLICABILITY

This disclosure relates to an apparatus for processing a stock/futures trades status as graphics. More particularly, the present disclosure relates to an apparatus for processing a stock/futures trades status in which a computing module capable of obtaining various stock/futures trades information about a stock/futures trades status for each stock/futures trading time zone and each stock/futures trading price range, a computing module capable of configuring a screen so that a stock/futures trading time and a stock/futures trading price respectively represent a horizontal axis and a vertical axis and capable of arranging a Cell for Recording a stock/futures trades Information (CRI) corresponding to the stock/futures trading time and the stock/futures trading price in the screen in a matrix format, a computing module capable of generating a Stock/futures trades information relation graph Tag (ST) corresponding to the stock/futures trades information for each stock/futures trading time zone and each stock/futures trading price range and capable of guiding the stock/futures trades information for each stock/futures trading time zone and each stock/futures trading price range to be displayed by inserting the generated ST into the CRI, or the like are systematically linked and disposed in a communication pipeline of an exchange system, which maximizes the visual readability of the stock/futures trades information corresponding to the stock/futures trades status and guides a person in charge at a stock exchange to recognize the change of the stock/futures trades information for each stock/futures trading time zone and each stock/futures trading price range in a lump without any difficulty so that, for example, movements of unfair speculative forces may be more easily monitored and exposed to minimize the damage of clients caused by the deterioration of the stock/futures trades status monitoring/managing quality.

1. An apparatus for processing a stock/futures trades status, comprising:
a stock/futures trades status graphics processing control module attached to a stock exchange terminal communicating with an exchange system that computes a stock/futures trades status or attached in the exchange system to generally control a procedure of processing the stock/futures trades status by graphics;
a stock/futures trades information obtaining module controlled by the stock/futures trades status graphics processing control module and communicating with the exchange system to obtain stock/futures trades information containing the stock/futures trades status for each stock/futures trading time zone and each stock/futures trading price range;
a screen configuring module controlled by the stock/futures trades status graphics processing control module to configure a screen so that a stock/futures trading time and a stock/futures trading price respectively represent a horizontal axis and a vertical axis, and to arrange a Cell for Recording a stock/futures trades Information (CRI) in a matrix format in the screen to correspond to the stock/futures trading time and the stock/futures trading price; and
a Stock/futures trades information relation graph Tag (ST) display module controlled by the stock/futures trades status graphics processing control module and communicating with the stock/futures trades information obtaining module to obtain the stock/futures trades information for each stock/futures trading time zone and each stock/futures trading price range, then to generate a ST corresponding to the obtained stock/futures trades information for each stock/futures trading time zone and each stock/futures trading price range, and to display the generated ST in the CRI.

2. The apparatus for processing a stock/futures trades status according to claim 1, wherein the ST display module includes:
a ST display control unit for generally controlling an overall ST display procedure;
a stock/futures trades information reading unit controlled by the ST display control unit to read the stock/futures trades information for each stock/futures trading time zone and each stock/futures trading price range obtained by the stock/futures trades information obtaining module;
a CRI location information obtaining unit controlled by the ST display control unit to confirm specific stock/futures trades information whose visualization is demanded, among the stock/futures trades information read by the stock/futures trades information reading unit, then to grasp the target stock/futures trading time and stock/futures trading price recorded in the confirmed specific stock/futures trades information, and to compare the grasped target stock/futures trading time and stock/futures trading price with <index data defining CRI location information for each stock/futures trading time zone and each stock/futures trading price range>, so that target CRI location information corresponding to the target stock/futures trading time and stock/futures trading price is obtained;
a ST generating unit controlled by the ST display control unit to confirm specific stock/futures trades information whose visualization is demanded, among the stock/futures trades information read by the stock/futures trades information reading unit, then to grasp the target stock/futures trades details recorded in the confirmed specific stock/futures trades information, and to combine and generate a target ST corresponding to the grasped target stock/futures trades details and target ST attribute information;
a ST display location obtaining unit in the CRI controlled by the ST display control unit to compare the target CRI location information and target ST attribute information obtained and generated by the CRI location information obtaining unit and the ST generating unit with <index data defining a ST display location of each ST attribute corresponding to the CRI location> so that <ST display location information in the target CRI> where the target ST will be displayed is obtained; and
a ST display unit controlled by the ST display control unit to confirm the target CRI where the target ST will be displayed, among the CRI configuring the screen, by referring to the <target CRI location information>, and then to display the target ST at a specific location of the target CRI by referring to the <ST display location information in the target CRI>.

3. The apparatus for processing a stock/futures trades status according to claim 2, further comprising a ST coloring unit controlled by the ST display control unit to compare the target ST attribute information with <index data defining color information of each ST attribute> and confirm a target color to be applied to the target ST or surroundings of the corresponding target ST, and then to apply the target color to the target ST or surroundings of the corresponding target ST by referring to the <ST display location information in the target CRI>.

4. The apparatus for processing a stock/futures trades status according to claim 1, further comprising a ST supplementary information providing module controlled by the stock/futures trades status graphics processing control module to read stock/futures trades information corresponding to the ST displayed in the CRI according to the request of the screen configuring module, then to generate ST supplementary information corresponding to the read stock/futures trades information, and to display the generated ST supplementary information at a region adjacent to the ST.

5. The apparatus for processing a stock/futures trades status according to claim 4, wherein the ST supplementary information providing module includes:
a ST supplementary information provision control unit for generally controlling a providing process of the ST supplementary information;
a stock/futures trades information reading unit controlled by the ST supplementary information provision control unit to read the stock/futures trades information for each stock/futures trading time zone and each stock/futures trading price range obtained by the stock/futures trades information obtaining module;
a ST supplementary information provision request receiving unit controlled by the ST supplementary information provision control unit to receive ST supplementary information provision request data transmitted from the screen configuring module;
a target ST characteristic information obtaining unit controlled by the ST supplementary information provision control unit to read details recorded in the ST supplementary information provision request data so that a location of a target ST requesting the provision of the supplementary information is grasped, and then to communicate with the ST display module to obtain characteristic information of the target ST;
a stock/futures trades information obtaining unit for the target ST controlled by the ST supplementary information provision control unit to read target ST attribute information, stock/futures trading time information, and stock/futures trading price information recorded in the characteristic information of the target ST so that a characteristic of the target ST is grasped, and then to obtain stock/futures trades information for the target ST corresponding to the target ST according to the grasped characteristic of the target ST, among the stock/futures trades information read by the stock/futures trades information reading unit;
a ST supplementary information generating unit controlled by the ST supplementary information provision control unit to generate ST supplementary information by summarizing and transforming the stock/futures trades information for the target ST into a report format; and
a ST supplementary information providing unit controlled by the ST supplementary information provision control unit to grasp a location of a target ST requesting the provision of the supplementary information, and then communicate with the screen configuring module to display the ST supplementary information at a region adjacent to the target ST.
